(19) United States
(12) Patent Application Publication
(10) Pub. No.: US 2007/0262853 A1
(43) Pub. Date: Nov. 15, 2007

(54) Vehicle alarm

(75) Inventors: Robert Bradus, Bel Air, MD (US); Fred S. Watts, New Freedom, PA (US)

Correspondence Address: THE BLACK & DECKER CORPORATION, 701 EAST JOPPA ROAD, TW199, TOWSON, MD, 21286, US

(73) Assignee: Black & Decker Inc., Newark, DE (US)

(21) Appl. No.: 11/800,345

(22) Filed: May 4, 2007

Related U.S. Application Data
(60) Provisional application No. 60/798,126, filed on May 5, 2006.

(51) Int. Cl. B60R 25/10; B60Q 1/00

(52) U.S. Cl. 340/426.25; 340/426.18; 340/426.22

(57) ABSTRACT

A vehicle may include a sensor module that is configured to monitor a vehicle for at least one alarm condition, a control module that is configured to receive an alarm signal from the sensor module, a local alarm module that is configured to provide at least one of an audible notification or a visual notification in response to an output signal from the control module, and a notification module that is configured to provide a remote notification of the alarm condition to a user.

### CROSS REFERENCE TO RELATED APPLICATION

This application claims the benefit of U.S. Provisional Application No. 60/798,126, filed May 5, 2006, and titled “Vehicle Alarm”, which is hereby incorporated by reference in its entirety.

### TECHNICAL FIELD

This description relates to a vehicle alarm that is capable of providing both a local alarm and a remote notification in response to a sensor being triggered.

### SUMMARY

In one general aspect a vehicle alarm may include a sensor module that is configured to monitor a vehicle for at least one alarm condition, a control module that is configured to receive an alarm signal from the sensor module, a local alarm module that is configured to provide at least one of an audible notification or a visual notification in response to an output signal from the control module, and a notification module that is configured to provide a remote notification of the alarm condition to a user.

Implementations may include one or more of the following features. For example, the sensor module and the control module may communicate using wired communications. The sensor module and the control module may communicate using wireless communications. The sensor module may include a diagnostic sensor that is configured to monitor a vehicle diagnostic port for the presence of at least one diagnostic signal. The diagnostic sensor may include a connector that mates to the vehicle diagnostic port. The connector may include a first end that mates to the vehicle diagnostic port and a second end that is configured to receive a diagnostic tool. The notification module may include a GPS module to determine a location of the vehicle.

In another general aspect, a vehicle alarm may include a diagnostic sensor that is configured to monitor a vehicle diagnostic port for at least one diagnostic signal, a control module that is configured to receive the diagnostic signal from the diagnostic sensor and to provide an output signal, and a notification module that is configured to provide a remote notification of an alarm condition to a user in response to receiving the output signal from the control module.

Implementations may includes one or more of the following features. For example, the diagnostic sensor may include a connector that mates to the vehicle diagnostic port. The connector may include a first end that mates to the vehicle diagnostic port and a second end that is configured to receive a diagnostic tool. The notification module includes a GPS module to determine a location of the vehicle. In another exemplary implementation, the diagnostic sensor may be a part of the control module and the control module may include a first connector that mates to the vehicle diagnostic port. The control module may include a second connector that is configured to receive a diagnostic tool.

Other features will be apparent from the description, the drawings, and the claims.

### DESCRIPTION OF DRAWINGS

FIG. 1 is a block diagram of an exemplary vehicle alarm system.

FIG. 2 is a block diagram of a portion of an exemplary vehicle alarm system.

FIG. 3 is a block diagram of a portion of an exemplary vehicle alarm system.

FIG. 4 is a block diagram of an exemplary vehicle alarm system.

FIG. 5 is a block diagram of an exemplary notification module.

FIG. 6 is a block diagram of an exemplary diagnostic sensor.

FIG. 7 is a block diagram of an exemplary diagnostic sensor.

FIG. 8 is a schematic diagram of an exemplary alarm detector circuit.

Like reference symbols in the various drawings indicate like elements.

### DETAILED DESCRIPTION

A vehicle alarm system may be used to protect a vehicle and its related contents (e.g., a tool box) from unauthorized entry and/or theft. The vehicle alarm system may detect unauthorized entry into a vehicle and/or its related contents and may sound a local alarm to ward off an intruder and send a notification to the vehicle owner or other designated party. The vehicle alarm system may be used on any type of vehicle including, but not limited to, cars, vans, trucks, commercial vehicles (e.g., fleet vehicles, construction vehicles and cargo vehicles), boats, aircraft, motorcycles, all terrain vehicles and recreational vehicles.

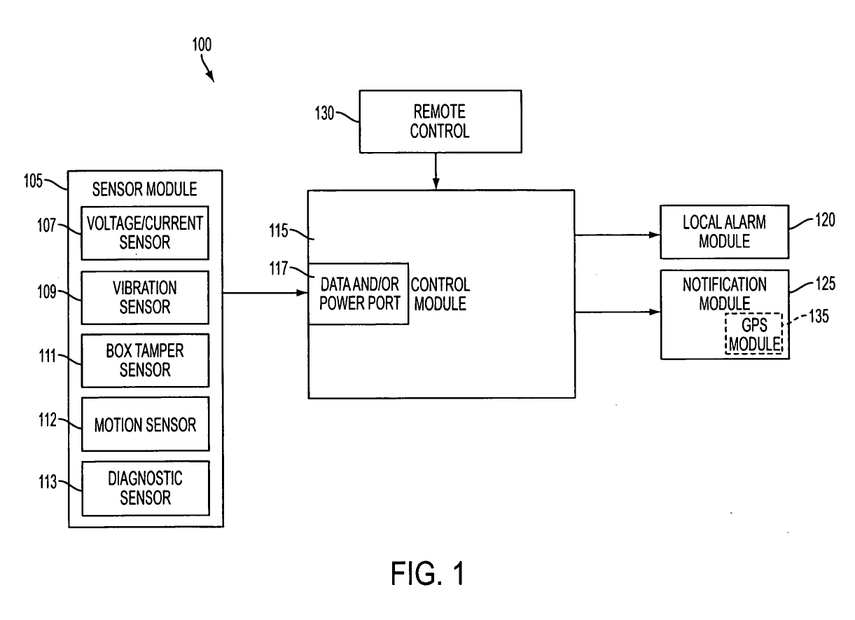

Referring to FIG. 1, a vehicle alarm system 100 may include a sensor module 105, a control module 115, a local alarm module 120, a notification module 125, and a remote control 130. The control module 115 may include a microprocessor-based control circuit, an analog-based control circuit, or other digital-based control circuit that may be configured to monitor the sensor module 105 and to provide an output signal to the local alarm module 120 and/or the notification module 125 in response to the sensor module 105 being triggered. The local alarm module 120 may provide an audible and/or visual alarm to ward off an intruder and the notification module 125 may send a notification to the vehicle owner or other designated party. The control module 115 may include a data and/or power port 117. The port 117 may be used to receive power input to the control module 115 and/or as a connection point to receive and send data through wired and/or wireless communications. The port 117 may be one or more ports.

The sensor module 105 may include one or more sensor components that may work independent of one another or in combination with one another. For instance, the sensor module 105 may include a voltage/current sensor 107, a vibration sensor 109, a box tamper sensor 111, a motion sensor 112, and/or a diagnostic sensor 113. Other sensors may include a GPS Geofence sensor, a vehicle tilt sensor, a vehicle rotation sensor (e.g., using a compass or gyroscope to detect a rotation of the vehicle), and a temperature sensor.

The voltage/current sensor 107 may be configured to monitor the vehicle battery voltage and detect changes in the battery voltage and/or current draw of the battery that occurs when lights, such as the dome light, the hood light and/or the trunk light, are illuminated. The vibration sensor 109 may be configured to monitor the vehicle for vibrations, such as vibrations associated with the opening of a vehicle door, a hood, and/or a trunk. The vibration sensor 109 also may be configured to monitor for vibrations associated with the breaking of a vehicle window. In one exemplary implementation, the vibration sensor 109 may measure the frequency and/or amplitude of vehicle vibrations and compare the measured values against configurable threshold vibration values. If the measured values meet and/or exceed the threshold vibration values, then the vibration sensor 109 is triggered.

The box tamper sensor 111 may be configured to monitor when a container (e.g., a tool box) on the vehicle has been opened. For example, the box tamper sensor 111 may include a tilt switch attached to the container and/or may include a vibration sensor attached to the container. The box tamper sensor 111 may be placed in or on the container. The motion sensor 112 may be configured to detect motion within the vehicle and/or to detect when the vehicle is in motion.

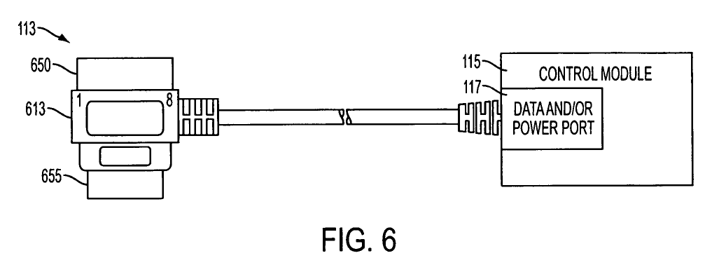

Referring also to FIG. 6, the diagnostic sensor 113 may include a connector, such as connector 613 shown in FIG. 6, that connects to a vehicle's onboard diagnostic connector. The vehicle's onboard diagnostic connector provides a connection point to the vehicle to obtain one or more diagnostic signals from the vehicle that are present when the vehicle engine is started. For example, there may be more than 300 diagnostic signals that may be present such as, for example, engine RPM's, vehicle speed, and catalytic converter temperature, just to name a few. The presence of one or more diagnostic signals may be used as an alarm event. The mere presence of the diagnostic signals may be used as an alarm event without having to decode a particular diagnostic signal. In that manner, there would be no need to interpret different manufacturer's diagnostic protocols. In other exemplary implementations, the diagnostic signals may be used by the control module 115 to determine specific information about the current status of the vehicle such as, for example, vehicle speed, engine RPMs, and other status information, as well as to be used as an alarm event. A user may be notified about this status information.

The connector 613 may include a first mating end 650 that plugs into a vehicle's onboard diagnostic connector such as, for example, a vehicle's OBD II connector. The connector may include a second mating end 655 that provides an available port that can be used to connect other vehicle diagnostic equipment such as equipment used by a vehicle mechanic to run diagnostic tests on a vehicle.

In one exemplary implementation, the diagnostic sensor 113 is wired to the control module 115 through the port 117. In this implementation, the connector 613 is configured to enable the signals from the vehicle's onboard diagnostic connector to be sent directly to the control module 115. In this manner, when a vehicle is turned on, diagnostic signals pass through the connector 613 to the control module 115.

In another exemplary implementation, the diagnostic sensor 113 detects diagnostic activity and communicates wirelessly with the control module 115 to indicate an alarm event. The diagnostic sensor 113 may receive power from the vehicle through the vehicles' onboard diagnostic connector.

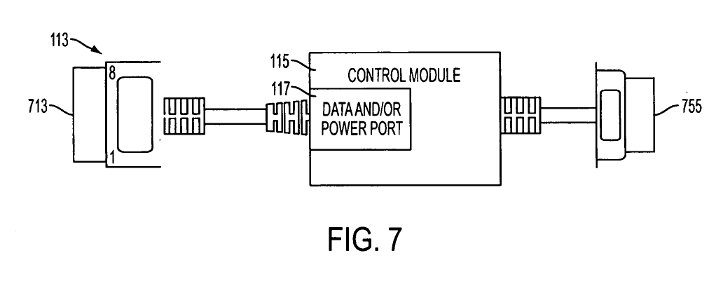

Referring to FIG. 7, the diagnostic sensor 113 includes a connector 713 that includes a single mating end that plugs into a vehicle's onboard diagnostic connector such as, for example, a vehicle's OBD II connector. The diagnostic sensor 113 is wired and/or wirelessly connected to the control module 115 through the port 117. In this implementation, the connector 713 is configured to enable the signals from the vehicle's onboard diagnostic connector to be sent directly to the control module 115. In this manner, when a vehicle is turned on, diagnostic signals pass through the connector 713 to the control module 115.

A connector 755 may be wired and/or wirelessly connected to the control module 115 to that provide an available port that can be used to connect other vehicle diagnostic equipment such as equipment used by a vehicle mechanic to run diagnostic tests on a vehicle.

Other sensors also may be used and monitored by the control module 115.

The sensor components may communicate with the control module 115 using wired, wireless, or a combination of wired and wireless communications. In one exemplary implementation, one sensor may communicate with the control module 115 using wired communications and another sensor may communicate with the control module 115 using wireless communications. The sensor components may include transceivers to enable wireless communications with the control module 115.

In response to one or more of the sensors being tripped, the control module 115 may send a signal to the local alarm module 120. The local alarm module 120 may include one or more devices that make an audible alarm and/or a visual alarm to ward off an intruder. For instance, the local alarm module 120 may include a sounding device (e.g., a siren or a speaker) that emits an audible alarm. The local alarm module 120 also may include a visual device such as, for example, a strobe light, that illuminates or flashes when a signal is received from the control module 115. The visual device also may include an interface that causes the vehicle's lights such as, for example, the headlights, taillights, and/or the brake lights, to illuminate and/or flash.

In one exemplary implementation, the local alarm module 120 may be configured as a “silent alarm.” For example, the control module 115 may not send a signal to the local alarm module 120 and instead only send a signal to the notification module 125.

In response to one or more of the sensors being tripped, the control module 115 sends a signal to the notification module 125. The notification module 125 may be configured to directly and/or indirectly notify the owner of the vehicle or other designated party that a sensor has been tripped. The notification module 125 is configured to provide the notification wirelessly. The other designated party may include a monitoring service that may notify the owner of the vehicle or other designated persons that a vehicle sensor has been tripped. In one exemplary implementation, the notification module 115 includes a cellular communication device that may be configured to send a cellular signal to the owner of the vehicle or other designated party. In other exemplary implementations, the notification module 115 may include other communication components to use other transmission methods to notify the owner or other designated party. The other transmission methods may include, for example, spread spectrum, WiFi, ZigBee, Cellemetry®, Satellite, and Mesh. The components necessary to support these and other transmission methods may be included as part of the notification module 115. These transmission methods may be used to communicate with a user device (e.g., a cell phone, a pager, a personal digital assistant (PDA), or an RF receiver) to alert the owner/designated party that a sensor has been tripped.

In one exemplary implementation, the notification module 125 may include a global positioning satellite (GPS) module 135. The GPS module 135 may include a GPS receiver, an aided GPS receiver, or an assisted GPS receiver that is capable of determining its location and, therefore, the location of the vehicle. Other types of receivers may be used in the GPS module such as, for example, a receiver that is configured to receive and process any type of radio frequency triangulation signals including Advanced Forward Link Trilateration (AFLT). The GPS receiver may provide a signal to a communication device that is part of the notification module 125, such that the notification module can communicate the location of the vehicle to the owner or other designated party using at least one of the transmission methods discussed above.

The vehicle alarm system 100 also may include a remote control 130. The remote control 130 may be configured to arm and disarm the system. For instance, a user may arm the vehicle using the remote control 130 when the vehicle is left unattended. The user may disarm the vehicle using the remote control 130 to enable the user to enter the vehicle without tripping one of the sensors. In one exemplary implementation, the remote control 130 may include a wireless key fob transmitter. When the vehicle is armed using the wireless key fob transmitter, a sounding device on the vehicle (e.g., a sounding device that may be part of the local alarm module 120) may make a first unique audible sound (e.g., a single chirp) or a visual indicator (e.g., a single blink) to indicate that the vehicle alarm system 100 has been armed. Similarly, when the vehicle is disarmed using the wireless key fob transmitter, the sounding device may make a second unique audible sound (e.g., a double chirp) or visual indicator (e.g., a double blink) to indicate that the vehicle alarm system 100 has been disarmed.

In one exemplary implementation, the remote control 130 may include an original equipment manufacture (OEM) key fob-type device, such as a key-fob device that comes with a vehicle to lock and unlock the vehicle doors. The control module 115 may be configured to learn and respond to these OEM key fob-type devices, such that these OEM key fob-type devices also may be used to arm and disarm the vehicle alarm system 100.

In another exemplary implementation, the notification module 125 also may be configured to send a notification signal directly to the owner using a user notification device. For example, the remote control 130 may be configured to operate as a user notification device that is capable of receiving a wireless signal from the notification module 125 when at least one of the sensors have been tripped. The system may be registered to the user notification device in a manner similar to how a home owner registers a garage door opener to its remote control or similar to how a person register the DeWALT SITELOCK™ DS 100. The user notification device may include a table top-type box or a device that a user could easily carry on his/her person. In one implementation, a key fob-type device may be configured to operate as a user notification device, such that the key-fob device could be used to arm and disarm the system and receive a signal from the notification module 125. The key fob device may provide an alert to the user (e.g., an audible or sensory (vibration) alert) to the user in response to receiving a signal from the notification module 125.

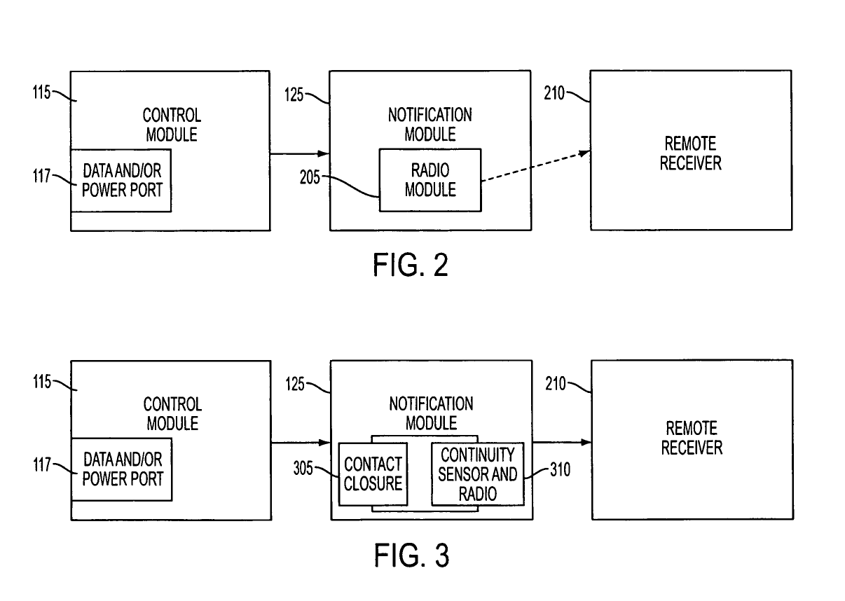

Referring to FIG. 2, in one exemplary implementation, the control module 115 sends a signal to the notification module 125, where the notification module 125 includes a radio module 205. In this exemplary implementation, when the notification module 125 receives a signal from the control module, the radio module 205 transmits a signal (e.g., a radio frequency (RF) signal) to a remote receiver 210. The remote receiver 210 may transmit a signal directly to the owner or to another designated party, such as a monitoring service. The remote receiver 210 may communicate to the owner or other designated party using, for example, a land line telephone, a cellular phone, electronic mail (e-mail), a text message, or other wired or wireless communication method.

Referring to FIG. 3, in one exemplary implementation, the control module 115 sends a signal to the notification module 125, where the notification module 125 includes a contact closure 305 and a continuity sensor and radio module 310. In this example, the signal output from the control module 115 causes the contact closure 305 to close, for example, using a relay. In another example, the signal output from the control module 115 may cause the contact closure 305 to open, for example, using a relay. The continuity sensor and radio module 310 may include a continuity sensor coupled to a radio transmitter. The continuity sensor and radio module 310 monitors the state of the contact closure 305. In response to a change in the contact closure 305 (e.g., the contacts change from an open position to a closed position or the contacts change from a closed position to an open position), the continuity sensor and radio module 310 transmits an RF signal to a remote receiver 210. The remote receiver 210 may communicate to the owner or other designated party using, for example, a land line telephone, a cellular phone, electronic mail (e-mail), a text message, or other wired or wireless communication method.

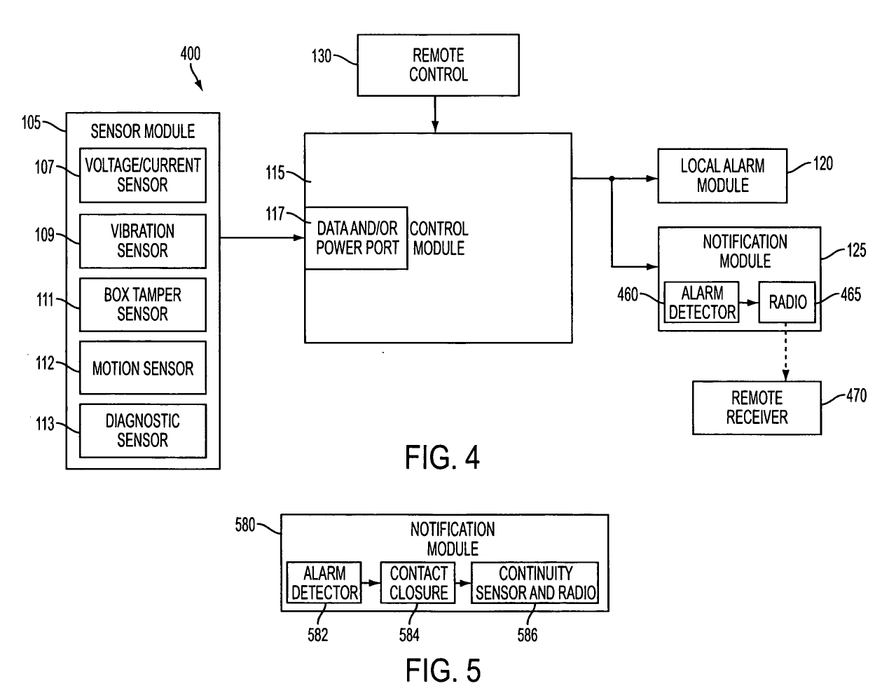

Referring to FIG. 4, in one exemplary implementation, a vehicle alarm system 400 includes a sensor module 105 having one or more sensors (e.g., voltage/current sensor 107, vibration sensor 109, and box tamper sensor 111, a motion sensor 112, and/or a diagnostic sensor 113), a control module 115, a local alarm module 120, a notification module 125, and a remote control 130, all of which may be configured to function as described above. In this exemplary implementation, the notification module 125 includes an alarm detector 460 and a radio 465. The alarm detector 460 may include analog and/or digital circuitry that is capable of distinguishing an audible alarm made by the local alarm module 120 from other audible output signal that may be produced by other components. Thus, when the alarm detector 460 detects an audible alarm from the local alarm module 120, the alarm detector 460 sends a signal to the radio 465, which then transmits an RF signal to a remote receiver 470. The remote receiver 470 may transmit a signal directly to the owner or to another designated party, such as a monitoring service. The remote receiver 470 may communicate to the owner or other designated party using, for example, a land line telephone, a cellular phone, electronic mail (e-mail), a text message, or other wired or wireless communication method.

Referring to FIG. 5, a notification module 580 may include an alarm detector 582, a contact closure 584, and a continuity sensor and radio module 586. In this exemplary implementation, the alarm detector 582 includes the functionality described above with respect to alarm detector 460 of FIG. 4. In FIG. 5, when the alarm detector 582 detects an audible alarm from the local alarm module, the alarm detector sends a signal to the contact closure 584. The contact closure 584 and the continuity sensor and radio module 586 then may function as described above with respect to the contact closure 305 and the continuity sensor and radio module 310 of FIG. 3.

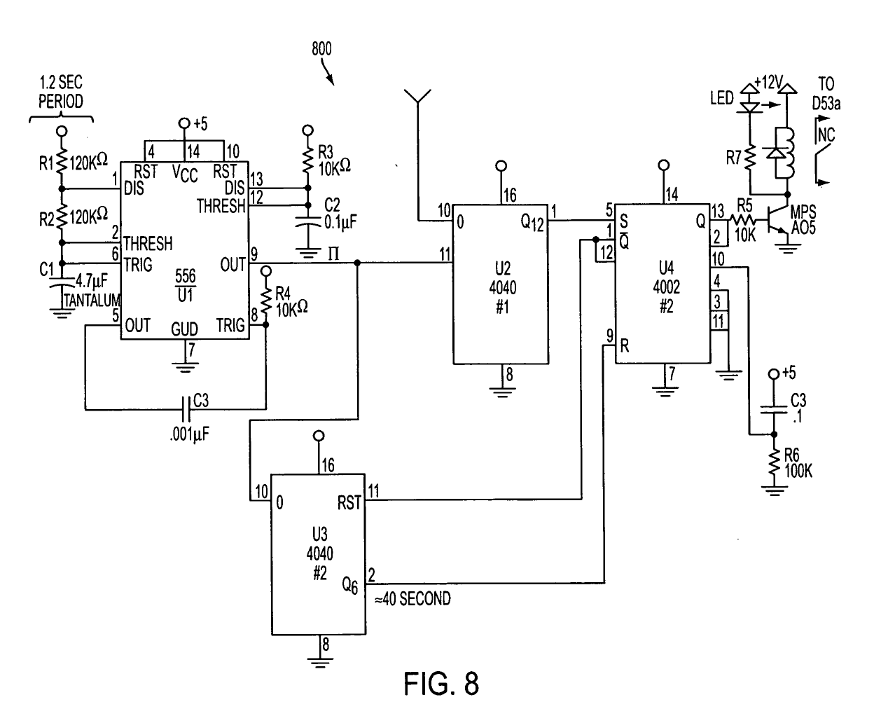

Referring to FIG. 8, an exemplary alarm detector circuit 800 is illustrated. The alarm detector circuit 800 may be used in alarm detectors 460 of FIG. 4 and 582 of FIG. 5. The exemplary alarm detector circuit 800 may provide the interface from the vehicle alarm system to a remote receiver (e.g., remote receiver 470 of FIG. 4). In one exemplary implementation, the remote receiver may include the DS100 base unit that is part of the DeWALT SITELOCK™ Portable Wireless Alarm System.

In one implementation, the control module (e.g., control module 115 of FIG. 4) sends a signal to the local alarm module (e.g., local alarm module 120 of FIG. 4). The control module generates the alarm frequency by outputting a square wave. The tone warbles, but the approximate frequency may be on the order of 3 kHz. The same output is used to signal when the system is armed (one “chirp”) and disarmed (2 chirps is no alarm has happened, 3 chirps if an alarm event happened). The alarm detector circuit 800 needs to distinguish between an alarm as sounded by the local alarm module and the arming/disarming chirps.

By measurement, the 3 chirp disarming output lasts approximately 600 milliseconds, including the pauses between each chirp. To simplify calculation, if we assume that frequency is constant at 3 kHz, and that there are no pauses, then there would be 1800 cycles of the microprocessor output square wave in 600 msec.

In an alarm event, the output continues to warble for approximately 35 seconds.

Referring to the FIG. 8, U1 is a 556 dual timer. As shown on the schematic, the left side is configured as an astable oscillator. R1, R2 and C1 are selected to provide a period of 1.14 seconds. This time was selected based on three criteria: (1) it is sufficiently longer than the 600 msec chirps, (2) it is not so long that additional arm/disarms initiated by the user might occur, and (3) when multiplied by a binary number (in this case 32) it is longer than the 35 second alarm time but not by a large margin.

The output of the astable oscillator is AC coupled to the trigger input on pin 8. The right side (as on the schematic) is configured in monostable mode (one-shot) to provide a logic “high” pulse of 1 msec duration once per each cycle of the astable oscillator. There will be a 1 msec pulse once each 1.14 seconds. This pulse is fed to the reset input of U2 and to the counter input of U3.

U2 is a binary ripple counter. The Q12 output will be low after reset, and will be high when 2048 cycles of the counter input have occurred. U2 receives a reset pulse every 1.14 seconds. Therefore, Q12 will be high only if 2048 cycles have occurred within 1.14 seconds. The counter input is connected to the output pin of the Optima-II+ microprocessor which generates the alarm tone. As explained above, the worst case disarming would generate about 1800 cycles in 0.6 seconds, and pressing the key after that is unlikely to happen within another ½ second, so the only way 2048 cycles would occur within the 1.14 second period is during an alarm.

U4 is an dual 4-input nor gate, configured as an S-R Flip Flop. C3 and R6 provide a power-on-reset input to ensure that, on power-up, the F/F is in the R (Reset) mode. In Reset Mode, the Q output is low, and the Q-bar output is high. If U2 receives 2048 cycles at its counter input within 1.14 seconds, U2's Q12 goes high, which then causes U4 to change from Reset to Set mode, turning Q output high and Q-bar output low. The Q output drives an NPN transistor which then allows the Relay and LED to turn on. The relay's contacts are connected in NC mode to the input of a DS300BO (e.g., the circuit used in the DeWalt DS300 Cable Lock). When the Q output of U4 goes high, the result is that the relay's contacts open. This generates an alarm radio signal to a remote receiver.

When Q-bar of U4 goes low, it allows U3 to come out of reset. U3's Q6 output will go from low to high when U3's counter receives 32 input cycles. Since input to U3's counter is every 1.14 seconds, U3's Q6 will go high in 32×1.14 or 37 seconds. When U3's Q6 goes high, it applies a Reset pulse to U4, at which time U4's Q output will return to its low state, turning off the Relay and LED. Note that a time could be increased to 74 seconds simply by connecting U4's Reset input to U3's Q7 instead of Q6.

What is claimed is:

1. A vehicle alarm comprising:
a sensor module that is configured to monitor a vehicle for at least one alarm condition;
a control module that is configured to receive an alarm signal from the sensor module;
a local alarm module that is configured to provide at least one of an audible notification or a visual notification in response to an output signal from the control module; and
a notification module that is configured to provide a remote notification of the alarm condition to a user.

2. The vehicle alarm of claim 1 wherein the sensor module and the control module communicate using wired communications.

3. The vehicle alarm of claim 1 wherein the sensor module and the control module communicate using wireless communications.

4. The vehicle alarm of claim 1 wherein the sensor module includes a diagnostic sensor that is configured to monitor a vehicle diagnostic port for the presence of at least one diagnostic signal.

5. The vehicle alarm of claim 4 wherein the diagnostic sensor includes a connector that mates to the vehicle diagnostic port.

6. The vehicle alarm of claim 5 wherein the connector includes a first end that mates to the vehicle diagnostic port and a second end that is configured to receive a diagnostic tool.

7. The vehicle alarm of claim 1 wherein the notification module includes a GPS module to determine a location of the vehicle.

8. A vehicle alarm comprising:
a diagnostic sensor that is configured to monitor a vehicle diagnostic port for at least one diagnostic signal;
a control module that is configured to receive the diagnostic signal from the diagnostic sensor and to provide an output signal; and
a notification module that is configured to provide a remote notification of an alarm condition to a user in response to receiving the output signal from the control module.

9. The vehicle alarm of claim 8 wherein the diagnostic sensor includes a connector that mates to the vehicle diagnostic port.

10. The vehicle alarm of claim 9 wherein the connector includes a first end that mates to the vehicle diagnostic port and a second end that is configured to receive a diagnostic tool.

11. The vehicle alarm of claim 8 wherein the notification module includes a GPS module to determine a location of the vehicle.

12. The vehicle alarm of claim 8 wherein the diagnostic sensor is part of the control module and the control module includes a first connector that mates to the vehicle diagnostic port.

13. The vehicle alarm of claim 12 wherein the control module includes a second connector that is configured to receive a diagnostic tool.
